(19) United States
(12) Patent Application Publication
(10) Pub. No.: US 2006/0200356 A1
(43) Pub. Date: Sep. 7, 2006

(54) On demand real-time knowledge-based connectivity

(76) Inventor: Dadong Wan, Palatine, IL (US)

Correspondence Address: ACCENTURE;C/O VEDDER PRICE KAUFMAN & KAMMHOLZ, P.C., 222 NORTH LASALLE STREET, CHICAGO, IL, 60601, US

(21) Appl. No.: 10/412,476

(22) Filed: Apr. 11, 2003

Related U.S. Application Data
(60) Provisional application No. 60/371,757, filed on Apr. 11, 2002.

(51) Int. Cl. G06Q 99/00

(52) U.S. Cl. 705/1

(57) ABSTRACT

A system and method for providing, on demand, real-time knowledge-based connection and communication between a layperson and an expert provider is disclosed. The system operates by receiving a request query from a user; providing the user with a plurality of appropriate providers; mapping an available provider based on user specifications; and connecting the user with one of the plurality of providers based on the user specifications. The system provides for the wireless connection and information exchange between the user and the expert based on the real-time user task environment.

### FIELD OF THE INVENTION

The present invention is generally related to interconnecting remote parties and, more particularly, to a system and method for enabling real-time connections and information transfer between a layperson and an expert based on knowledge of the layperson's environment.

### BACKGROUND OF THE INVENTION

As technology becomes a greater part of our lives, the myriad electronic and other products give consumers unlimited choices of products from which to choose. In addition to choosing which of the many products and services is best for their particular environment or circumstance, consumers are oftentimes responsible for installing and troubleshooting the products. Telephone-based customer service and Internet-based support are generally made available by manufacturers, wholesalers and retailers to assist consumers when they are having difficulty; however, such support may not be adequate when, for example, the consumer or product user is not able to articulate what the problem is. This can arise from the consumer being unfamiliar with the product or its installation and general use.

In addition to telephone and Internet-based support, consumers can hire an independent and/or professional installer or repairperson to install and troubleshoot a consumer's system. However, hiring a third party can be both time-consuming and expensive, as independent contractors often charge by the hour, with the charging period beginning from when they leave their offices. Also, depending on the distance between the consumer and the independent contractor, the time for receiving service may be prohibitive.

Moreover, consumers may feel uncomfortable or too embarrassed to call upon a contractor to provide them with service. In that situation, they go forward with the installation or repair on their own; often with disastrous results.

Thus, there is a present need for an on-demand real-time communication system where a consumer or product user can connect to an expert in an appropriate field and receive advice from the expert in order to complete projects at the consumer location.

### BRIEF DESCRIPTION OF THE DRAWINGS

The present invention, and the associated advantages and features provided thereby, will be best understood and appreciated upon review of the following detailed description of the invention, taken in conjunction with the following drawings, where like numerals represent like elements, in which:

FIG. 1 is a schematic block diagram of a knowledge-based entity interconnection system according to a first exemplary embodiment of the present invention;

FIG. 2 is a flowchart illustrating the operating steps performed by the service provider application of the system illustrated in FIG. 1;

FIG. 3 is a schematic block diagram of a knowledge-based entity interconnection system according to a second exemplary embodiment of the present invention;

FIG. 4 is a schematic block diagram of the expertise manager/market broker manager illustrated in FIG. 1 and FIG. 3, respectively; and

FIG. 5 is a flowchart illustrating the operating steps performed by the market broker manager illustrated in FIG. 3 and FIG. 4.

### SUMMARY OF THE INVENTION

Briefly stated, the present invention is directed to a system and corresponding method for providing on-demand interconnection between a first entity and a second entity and information exchange based on the real-time delivery of first entity environment information to the second entity. In an exemplary embodiment, the first entity may consist of a consumer or other layperson and the second entity may consist of an expert in a given field. For example, the second entity may include an electrician, a carpenter or an individual working for a larger commercial entity, such as a store. Information exchange between the layperson and the expert is conducted in real-time, such that the expert receives immediate information relating to the consumer problem or the environment with which the consumer or layperson is working and provides advice or suggestions on how to resolve problems the layperson may be experiencing.

The knowledge-based connection system of the present invention includes means for receiving a user request, the receiving means, including voice recognition capability; means for maintaining a list of providers and providing a subset of the provider list in response to the user request; means for determining whether each of the providers is capable of transferring information with the user; and means for providing a connection between the user and one of the providers, wherein the voice and environment information of the user is transmitted to one of the providers in real time. The connection system further includes means for monitoring the amount of time the user is connected to the provider or expert, thereby providing the ability to engage in time-based or task-based billing of provider services. Alternatively, the present invention can be implemented on a charge-free basis.

In application, the knowledge-based connection method of the present invention operates by receiving an oral query from a user; providing the user with a plurality of appropriate providers based on the query; mapping an available provider based on user specifications; and connecting the user with one of the plurality of providers based on the user specifications. Upon connecting to the appropriate provider, the user is able to directly communicate and provide the provider with a real-time image of the user's environment which, in turn, will enable the provider or expert to give the user accurate and immediate advise on how to troubleshoot and otherwise correct the problem, By providing for the real-time exchange of information between a user and an expert, the user saves money by not having to pay for expert at-home service charges or fees. Additionally, time savings are provided by the user not having to wait for an expert to make an at-home visit.

### DETAILED DESCRIPTION OF THE INVENTION

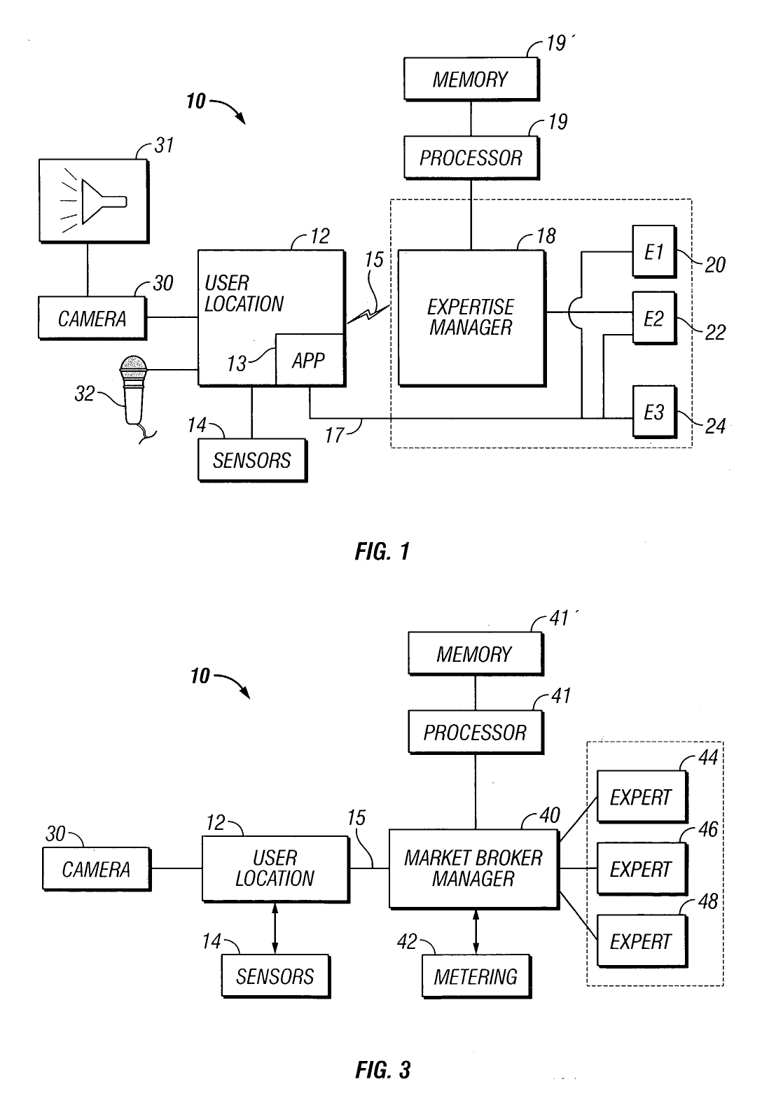

An exemplary embodiment of the present invention will now be described with reference to FIGS. 1-5. Referring to FIG. 1, illustrated therein is a schematic block diagram of a personal knowledge-based connection system 10 according to the present invention. The system is referred to as a personal knowledge-based system because it provides a connection between a user's (or layperson's) location 12 and that of a specific provider 16. Examples of a specific provider are Circuit City, Home Depot, Ace Hardware or any entity that provides consumer goods. Alternatively, the knowledge-based connection and information transfer system of the present invention can be implemented as a kiosk (or other stand-alone location) within a specific provider. This differs from the market broker knowledge-based system that will be described in greater detail with respect to FIGS. 3-5.

As shown, the personal-based connection system 10 includes a user location 12, which is connected to a specific provider through a communication link 15. In the embodiment illustrated in FIG. 1, the communication link 15 is provided by the Internet. However, it will be appreciated by those of ordinary skill in the art that the communication link can also be performed over a local area network (LAN), a wide area network (WAN), or any suitable land-line and/or wireless network.

Sensor 14, such as, for example, temperature sensors, humidity sensors, light sensors or any other suitable (wireless or wire-line) sensing device may be used to detect the user's environment and transmit information related thereto to the provider 16. A camera, preferably a digital camera having wireless transmission capabilities 30, equipped with an illuminating mechanism (e.g., a light) 31 may be used to provide a visual image of the user's environment (or problem to resolve) within the user location 12 and transmit such visual image to the provider 16 over the communication link 15. A wireless microphone 32 or appropriate transceiver may be used to provide verbal information transfer between the user and the expert, either alone, or simultaneously with the visual image of the user environment over the communication link 15. In an exemplary embodiment, the voice and/or image information is transmitted to the communication link 15 through a suitable application 13 that is running within or about location 12. In this fashion, the user is able to move about the particular location 12, and is not restricted to any specific or otherwise limited area.

The provider 16 includes an expertise manager 18, which in an exemplary embodiment may act as a searchable database utilizing a processor 19 and a memory 19, which maintains a directory of available experts (E1, E2, E3) 20-24, respectively, that are available to receive the information regarding the user environment and provide advice on how to resolve any user issues or other troubleshooting problems. The expertise manager 18 may be equipped with a voice recognition engine for converting the user's oral requests and/or questions into a digital format that is more suited for transmission over the communication link 15. The expertise manager 18 may also be equipped with a second (i.e., text-to-speech) engine for providing a means for the experts to communicate directly with the user. It will be appreciated and recognized by those of ordinary skill in the art that the voice recognition engine and/or the text-to-speech engine can be part of application 13 maintained at the user location 12.

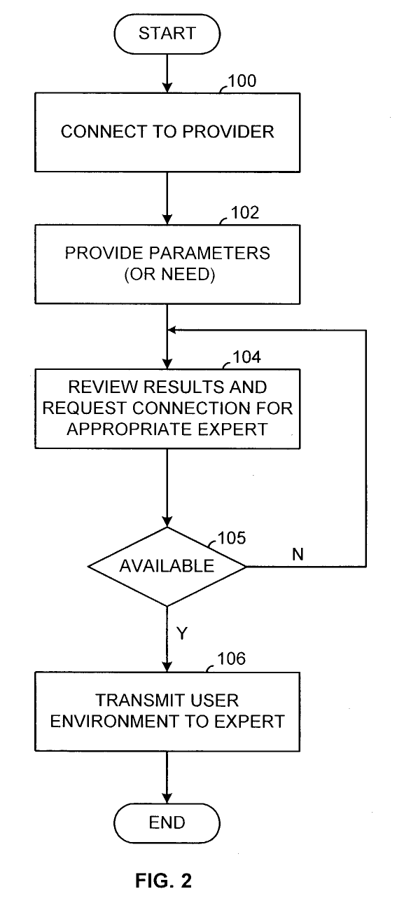

In the embodiment of FIG. 1, the experts 20-24 are associated with the provider 16 of the service. Thus, using an electronics store as an example, each of the experts 20-24 are employees or contractors of the electronic store provider. However, it should be noted that the employees are not limited to reside within a particular location. For example, experts 20 and 22 may reside in one location, while expert 24 resides in another location. Accordingly, if expert 24 is the most appropriate individual to answer the user request, expert 24 will be connected to and communicate with the user. The operation of the system illustrated in FIG. 1 will now be described with reference to FIG. 2.

FIG. 2 is a flowchart illustrating the operating steps performed by the knowledge-based connection system shown in FIG. 1. The process begins at step 100 with the user or layperson connecting to the provider 16 by orally requesting assistance for a particular problem. The request is received by the voice recognition engine of the expertise manager 18 through communication link 15, as shown in FIG. 1. Next, the expertise manager 18 requests the layperson to communicate the general nature of the problem and the parameters of the problem (e.g., context within which the problem exists). Such information is received in step 102. The process then moves to step 104.

In step 104, the expertise manager 18 searches the database of provider employees and contractors and provides the layperson with a list of available experts 20-24 (shown in FIG. 1), based on the information provided by the user via the text-to-speech engine. The layperson then reviews the list and selects one of the available experts to be connected to. The process then proceeds to step 105.

In step 105, a determination is made as to whether the selected expert is available for a consultation. If the selected expert is not available, the process moves back to step 104 where the expertise manager 18 requests the layperson to make another selection. On the other hand, if the selected expert is available, the process moves to step 106.

In step 106, the layperson's request and operating environment is transferred to the expert for review. While connected to the expert, the layperson can discuss the problem with the expert, provide the expert with a real-time image of the problem context by transmitting the image through the use of a wireless camera or a simultaneous transmission of both image and voice information. Alternately, the layperson can be connected to the expert through a direct communication link 17. The session can be terminated by either the layperson or the expert once the layperson's questions have been satisfactorily answered or the issues adequately resolved.

The aforementioned provider-based system can be implemented as a fee-based system or a free system depending on the interests or objectives of the provider. If the provider-based system is to be implemented as a fee-based system, the expertise manager 18 may include time-monitoring functionality, which monitors the amount of time the user is connected to the expert, and bills the user for such time, or the user may be billed on a fixed-fee basis. With either billing method, the user will be queried to provide the expertise manager 18 with a method of payment. Such payment methods can include credit card information, debit card information, billing address information, store account information, or any other suitable proprietary or nonproprietary payment method.

By using the provider-based system of the present invention, the user saves money by not having to pay for an in-home visit. Additionally, the time spent resolving an issue may also be tremendously reduced by the user not having to wait for an expert to travel to the user location to troubleshoot and resolve the problem. Also, the user may be empowered to undertake other projects and return to the particular provider 16 for the components to complete such projects, based on the satisfactory use of the knowledge-based connection system of the present invention.

FIG. 3 is a schematic block diagram of a knowledge-based connection system 10 according to an alternate embodiment of the present invention. The connection system 10 is referred to as a market broker or participant-based system because it provides for a connection between a user (at a particular remote location) 12 and one of a plurality of experts 44-48 that are independent from each other. This differs from the personal knowledge-based system illustrated in FIG. 1, in that, the experts that the user or layperson are connected to, are not affiliated with the same entity.

As illustrated in FIG. 3, the connection system 30 includes a market broker manager 40, operative to provide a real-time connection between the user or layperson, at a remote location 12, and one of a plurality of experts 44-48, based on the layperson's particular situation, and a metering block 42 operative to, for example, monitor the amount of time the layperson spends connected to a particular one of the plurality of experts. The experts may be present at locations remote from one another, or they may be present in the same location (as illustrated by the dashed outline).

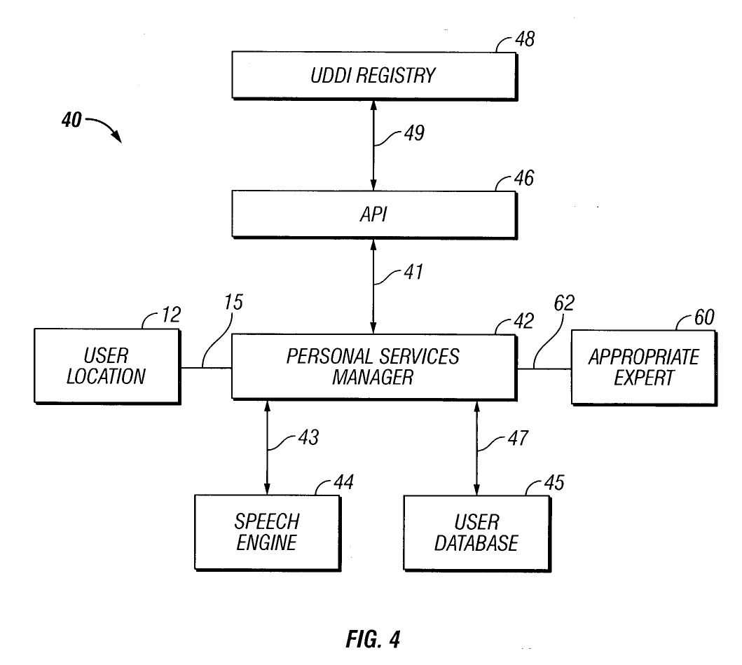

In addition to monitoring connection time, the metering block 42 may also be configured to calculate any charges as part of a fee-based service, and receive and process payment information such as, for example, credit card information, debit card information, or any proprietary payment information. Other services or processes that may be performed by the metering block 42 include searching, providing security over the information transferred or payment information, and/or providing quality assurance benefits to the user. It should also be noted that connecting to an expert may be provided as a free service by a host. The market broker manager 40 will now be described with reference to FIG. 4.

As illustrated in FIG. 4, the market broker manager 40 includes a personal services manager 42 who is operative to receive an oral description of the problem the user (e.g., the layperson) is trying to resolve and/or real-time video illustrating the problem the user is trying to resolve and providing a link between the user and an appropriate expert 60 on-line 62 based on the received information.

A speech engine 44 is coupled to the personal services manager 42, and is operative to perform speech recognition such that the speech engine converts the voice and any corresponding oral commands of the user into appropriate digital signals for further use and transmission by the personal services manager 42. In an exemplary embodiment, speech recognition is performed by an engine such as IBM ViaVoice. The speech engine 44 also performs text-to-speech synthesis, where digital signals are converted into audible sounds (e.g., words) that the user can understand. In the embodiment, the text-to-speech synthesis is performed by the AT&T Natural Voices engine. However, any suitable text-to-speech engine can be used without deviating from the spirit and scope of the present invention.

A Web Services API 46 couples a UDDI Registry 48 to the personal services manager 42. The UDDI Registry 48, in one embodiment, is configured as a database that maintains a searchable list of experts in myriad fields. The expert list includes information relating to each of the experts maintained in the UDDI Registry including, for example, the connection capabilities of the expert, the location of the expert, an indication of whether the expert is available for consultation, the technical blueprints (or t-models), which explain how, programmatically, to bind and invoke an expert service and any fees charged by the expert, to name just a few. It will be appreciated by one of ordinary skill in the art that the aforementioned list of expert information is not exhaustive and any appropriate information relating to the experts that falls within the may be maintained in the personal services manager and falls within the spirit and scope of the present invention.

In addition, the experts may be business or commercial entities, as well as individual persons. If the selected expert is a business entity, such entity may, for example, implement a connection system similar to that described with reference to FIGS. 1 and 2 in order to connect the use with an individual expert who can answer an user question. Searching of the UDDI Registry 48 is performed, for example, using the XML/SOAP-based query patterns and protocols, as specified in the UDDI 2.0 API specification.

A user database 45 is also coupled to the personal services manager 42 and is operative to store user preferences relating to, for example, the maximum amount of fees to be paid for advice or services, preferred location and experience level of experts, billing information and any technical information pertinent to the environment of the user. Although, the speech engine 44, user database 45, API 46 and UDDI Registry 48 are described as being separate components, it will be appreciated by one of ordinary skill in the art that the aforementioned components can be integrated within the personal services manager 42, and such a configuration is contemplated by and falls within the spirit and scope of the invention. For example, the market broker manager 40 illustrated in FIG. 4 can be implemented as a processor 41 connected to and operating according to instructions that are maintained within a memory 41. Also, it should be noted and appreciated that the expertise manager 18 can be implemented in similar fashion to the personal services manger 42 described above.

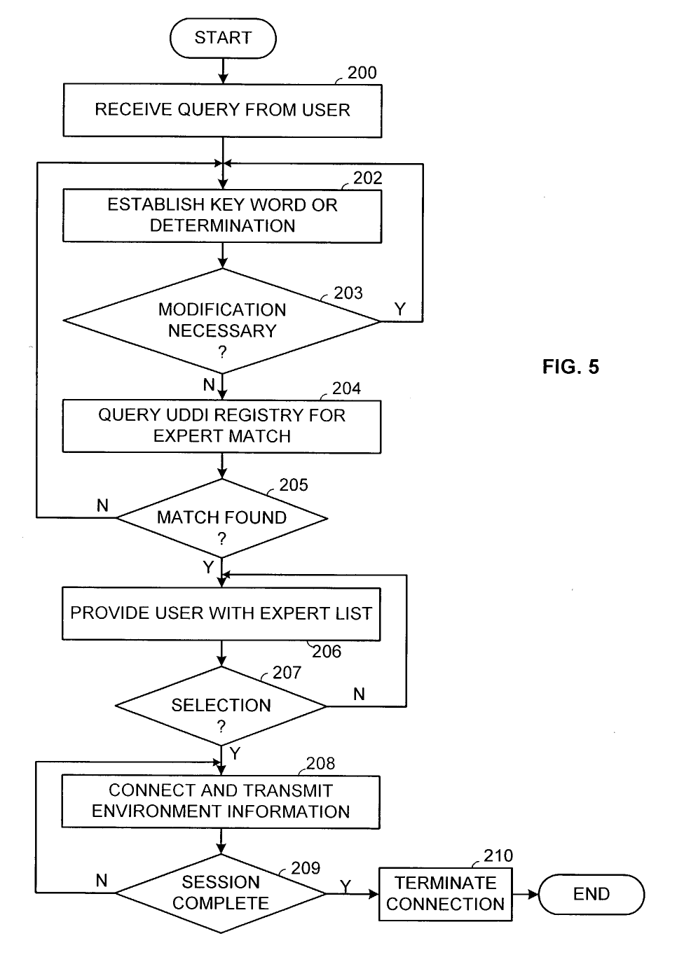

Referring back to FIG. 3, the user location 12 is connected to the market broker manager 40 via communication link 15. In the embodiment illustrated in FIG. 3, the communication link 15 is provided by the Internet. However, it will be appreciated by those of ordinary skill in the art that the communication link 15 can also be provided by a local area network (LAN), a wide area network (WAN), or appropriate land-line and wireless networks. The user location 12 also includes sensors 14, which may also include, temperature sensors, humidity sensors or a digital camera 30 equipped with a lighting element that is adapted to wirelessly transmit video images over the communication link. A wireless microphone (not shown) or any other means for transmitting voice data over the communication link 15 may also be coupled to or provided within the user location. Market broker system operation of the present invention will now be described with reference to FIG. 5.

Referring now to FIG. 5, the method begins at step 200 with the user or layperson connecting to the market broker manager and providing an oral request for expert assistance. In this step, the oral query (e.g., “I need help connecting a phone jack to the wall”) is received by the ViaVoice engine and converted into digital signals for use by the personal services manager 42. The process then proceeds to step 202.

In step 202, a keyword determination (e.g., “Phone” “Jack” and “Connection”) is generated by the personal services manger 42, based on the oral request, and the keyword(s) from the request are provided to the user for modification or confirmation by the text-to-speech engine.

Next, in step 203, a determination is made as to whether a modification to any determined keywords is necessary. If a modification is necessary, or the layperson wants to modify the request, the process moves back to step 202 where the layperson modifies the request and the modified request is received by the personal services manager. On the other hand, if modifications are not necessary, the process moves to step 204.

In step 204, the personal services manager 42 generates an XML/SOAP query pattern based on the keywords and searches the UDDI Registry 48 for at least one expert that meets the layperson requirements in step 205. If no match is found, the process moves back to step 202, where the personal service manager 42 requests the layperson for a new query (e.g., “Your query resulted in no matches, please make another request”) via the text-to-speech engine. After the new query is received, the keyword(s) are modified and a new search is conducted. If a match is found in step 205, the process moves to step 206.

In step 206, the personal services manager 42 provides the layperson with a list of expert matches (e.g., “John Smith, Smith electric,” “Home Depot,” “Alexander Jones”), along with any contact and t-model information, through the text-to-speech engine and waits for the layperson to select an expert in step 207. Once a selection is made (e.g., “John Smith”) and the t-model information between the layperson location 12 and the expert matches, the voice and video information, if any, of the layperson environment (e.g., the outlet where the phone jack is to be connected) is simultaneously transmitted to the selected expert via communication link 15 in step 208. In this manner, the expert is provided with a real-time image of the phone jack and where it is to be connected and can provide the layperson with step-by-step instructions on how to connect the phone jack with the actual layperson environment as the model. If the t-model information between the layperson location 12 and the expert does not match, the layperson will be alerted of the mismatch and be asked to enter a new selection (e.g., “Connection not possible at this time, please make another selection”).

In fee-based embodiments, the metering block 42 requests the user or layperson to enter the method of payment (e.g., credit card, debit card, etc.) and then keeps track of the amount of time the user is connected to the expert and calculates a bill based on the connection time. Alternately, in fixed-fee based services, the user is charged once connection is made to the expert.

In step 208, the personal services manager determines whether the session has been terminated. If the session is complete, the process moves to step 210 where the connection between the layperson and the expert is terminated (e.g., “connection to John Smith terminated”).

The above detailed description of the present invention and the examples described therein have been provided for the purposes of illustration and description. Although an exemplary embodiment of the present invention has been described in detail herein with reference to the accompanying drawings, it is to be understood that the present invention is not limited to the precise embodiments disclosed, and that various changes and modifications to the invention are possible, in light of the above teaching. Accordingly, the scope of the present invention is to be defined by the claims appended hereto.

What is claimed is:

1. A method for providing real-time entity interconnection, comprising:
receiving a request query from a user;
providing the user with a plurality of appropriate service providers;
mapping an available provider-based on user specifications; and
connecting the user with one of the plurality of service providers based on the user specifications.

2. The method of claim 1, wherein the mapping step further comprises:
receiving an initial service provider selection from the user;
determining whether the selected service provider is capable of being connected to the user; and
providing an indication of connectivity.

3. The method of claim 1, wherein the connecting step further comprises:
receiving a final service provider selection from the user; and
transmitting environment data to the selected service provider.

4. The method of claim 3, wherein the transmitting step further comprises:
establishing a connection to the selected service provider; and
transmitting real-time video data of the user environment.

5. The method of claim 1, further including receiving voice communications from the user and simultaneously receiving video information of the user environment.

6. A method for providing knowledge-based connectivity, comprising:
receiving an oral query from a user;
providing the user with a plurality of appropriate service providers in response to the query;
mapping an available service provider based on the user environment;
receiving real-time video environment information of the user environment; and
connecting the user with one of the plurality of service providers.

7. The method of claim 6, further including receiving a service provider selection from the user and determining whether the selected service provider is capable of receiving environment information from the user.

8. The method of claim 6, further including receiving connection data from the user and scanning a queue of available service providers for a connection and request match.

9. The method of claim 7, further including connecting the user with the selected provider.

10. The method of claim 9, further including transmitting the video environment information to the selected service provider.

11. The method of claim 10, further including simultaneously transmitting voice data with the video environment information.

12. The method of claim 6, further including monitoring the amount of time the user is connected to one of the plurality of service providers.

13. The method of claim 12, further including calculating a payment amount based on the monitored connection time.

14. The method of claim 13, further receiving a method of payment from the user.

15. A system for providing knowledge-based connectivity, comprising:
means for receiving a user request, the receiving means including voice recognition capability;
means for maintaining a list of service providers and providing a subset of the service provider list in response to the user request;
means for determining whether each of the service providers is appropriate and available for transfer of information to and from the user; and
means for providing a real-time connection between the user and one of the service providers.

16. The system of claim 15, further including means for simultaneously receiving voice and video information of the user environment.

17. The system of claim 16, further including means for capturing the user environment, the capturing means further including means for illuminating the user environment, a camera for providing an image of the user environment and means for transmitting the image to one of the service providers.

18. The system of claim 17, wherein the image is a digital image.

19. The system of claim 15, further including means for monitoring the amount of time the user is connected to one of the service providers.

20. The system of claim 19, further including means for calculating billing information based on the monitored connection time.

21. The system of claim 15, further including means for establishing a user account.

22. A knowledge-based connection system, comprising:
a processor; and
a memory coupled to the processor and maintaining instructions that, when executed by the processor, cause the processor to: receive a request from a user; providing the user with a plurality of appropriate service providers in response to the query; mapping an available service provider based on the user environment; receiving real-time video environment information of the user environment; and connecting the user with one of the plurality of service providers.

23. The system of claim 22, wherein the memory further maintains instructions that cause the processor to receive a service provider selection from the user and determine whether the selected provider is capable of receiving environment information from the user.

24. The system of claim 22, wherein the memory further maintains instructions that cause the processor to transmit real-time video information of the user environment to one of the plurality of service providers.

25. The system of claim 22, wherein the user request is oral and the memory further maintains instructions that cause the processor to convert the oral request into a format suitable for execution by the processor.

26. The system of claim 25, wherein the memory further maintains instructions that cause the processor to simultaneously transmit user voice and video information in real time.

27. A system for providing knowledge-based connectivity, comprising:
means for receiving a user request;
means for maintaining a list of service providers and providing a subset of the service provider list in response to the user request;
means for determining whether each of the service providers is appropriate and available for transfer of information to and from the user; and
means for providing a real-time connection between the user and one of the service providers.

28. A system for providing knowledge-based connectivity, comprising:
means for receiving a user request;
means for maintaining a list of service providers and providing a subset of the service provider list in response to the user request; and
means for providing a real-time connection between the user and one of the service providers.

29. A system for providing real-time on-line service providers, comprising:
means for receiving a user request;
means for selecting a service provider from a database of service providers; and
means for providing a real-time connection between the user and one of the service providers.

30. An interactive system for providing real-time on-line service from a service provider, said system comprising:
means for capturing the user environment, the capturing means further including means for illuminating the user environment, a camera for providing an image of the user environment and means for transmitting the image to one of the service providers.
